(19) United States
(12) Patent Application Publication
(10) Pub. No.: US 2012/0213319 A1
(43) Pub. Date: Aug. 23, 2012

(54) Fast Pulsed Neutron Generator

(75) Inventors: Joe Kwan, Castro Valley, CA (US); Qing Ji, Albany, CA (US); Ka-Ngo Leung, Hercules, CA (US)

(73) Assignee: The Regents of the University of California, Oakland, CA (US)

(21) Appl. No.: 13/384,578

(22) PCT Filed: Aug. 13, 2010
(86) PCT No.: PCT/US2010/045488

§ 371 Date: May 2, 2012

Related U.S. Application Data
(60) Provisional application No. 61/234,085, filed on Aug. 14, 2009.

(51) Int. Cl. G21G 1/10; H01J 27/02

(52) U.S. Cl. 376/199; 250/423 R; 376/190

(57) ABSTRACT

An apparatus and method for fast pulsing of a neutron generator is described in which a series of electrodes are used to first extract deuterium or tritium ions from a plasma contained within an ion source, and then either accelerate or stop the flow of ions to the source, depending upon the voltage potential applied to the downstream electrodes. In one embodiment, the extraction/gating system comprises 3 electrodes, a first extraction electrode which is maintained at the same positive potential as the ion sources, a second electrode maintained at a lower potential to extract ions from the source, and a third electrode which depending on the operational mode is maintained either at the same potential as the second electrode (for beam passage) or at a potential higher than that of the first electrode (for beam blockage).

### RELATED PATENT APPLICATIONS

This application is the national phase application of International application number PCT/US2010/045488, filed Aug. 13, 2010, which claims priority to and the benefit of U.S. Provisional Application 61/234,085, filed Aug. 14, 2009, which is herein incorporated by reference in its entirety.

### STATEMENT OF GOVERNMENTAL SUPPORT

The invention described and claimed herein was made in part utilizing funds supplied by the U.S. Department of Energy under Contract No. DE-AC02-05CH11231. The government has certain rights in this invention.

### BACKGROUND OF THE INVENTION

1. Field of the Invention

This invention relates generally to neutron generators, and, more particularly, to a method and apparatus for creating fast-pulsed beams for such generators.

2. Description of the Related Art

Active neutron interrogation has been demonstrated to be an effective method of detecting both explosives and shielded fissile material in, for example, cargo containers. In the case of explosives, the energy of the neutrons passing through a sample in such a container can be measured. With the attenuation of the neutron energies a function of the nature of the materials encountered by the neutron beam, the elemental composition of the target material can be determined: i.e., whether or not the sample presents such explosive containing elements as N, H, C, and O, especially elevated levels of N. In the case of shielded fissile material, the penetrating ability of neutrons allows them to “see” through material that may be surrounding the fissile material. When the neutrons interact with fissile material they induce fission resulting in the emission of neutrons and gammas that may then be detected.

A fast pulsing/fast fall-time neutron generator interrogation system can be used for both types of detection modalities. In the case of fissile material, Differential Die-Away (DDA) analysis has been used to measure the fissile content of nuclear waste containers, and is a sensitive technique for detecting the presence of fissile materials such as ²³⁵U and ²³⁹PU. In DDA analysis, a neutron generator produces repetitive pulses of neutrons that are directed into a cargo container that is under inspection. As each pulse passes through the cargo, the neutrons are thermalized and absorbed. The thermalization process is very rapid and the epithermal neutrons decays within microseconds. The thermal neutrons, however, decay much slower, which is on the order of hundreds of microseconds. If Special Nuclear Material (SNM) is present, the thermalized neutrons from the source will cause fissions that produce a new source of neutrons. These fast fission neutrons decay with a time very similar to that of the thermal neutron die-away of the surrounding cargo. Fast fall-off of the neutron pulse and low neutron background serves to improve the DDA signal and thus SNM detection. See References [1], [2], and [3].

In the case of interrogation of cargo containers for the detection of explosives, Pulsed Fast Neutron Transmission Spectroscopy (PFNTS) has been applied, employing a point neutron source with ultra short pulse widths in the order of about 2-10 nano seconds, such short pulses required for the necessary time of fight measurements. The use of PFNTS analysis is further described in commonly owned PCT Application PCT/US2007/087560, which application is incorporated herein by reference.

The basic principle of a neutron generator is to bombard an ion beam of either deuterium (D) or tritium (T) onto a target. Neutrons are produced via the D-D, D-T, or T-T reactions if the target surface is loaded with the D or T molecules. By on/off switching of the deuterium or tritium ion beams reaching the target, one can thus obtain a pulsed neutron source.

There have been several approaches undertaken to produce nano-second ion beam pulses. Beam chopping is the most common technique and is being applied with many accelerator systems. In this approach, a dc or long pulse ion beam is first extracted from an ion source. It is then accelerated and focused by using an Einsel lens. A parallel plate deflector is used to swipe the focused ion beam across a collimator slit. Ion beam pulses will be formed whenever the beam passes through the slit. The narrower the slit width and the faster the beam sweep rate, the shorter will be the beam pulse length.

In this scheme, the switching time is determined by the speed of the traverse sweeping and the beam size with respect to the aperture of the collimator. To keep the neutron background low, two-stage acceleration is required. Thus, the beam is first accelerated to a medium energy for transverse sweeping. After going through the collimator, it is then further accelerated to its full energy for neutron generation. The requirement of using extra electrodes and a fast pulsing high voltage power supply to sweep the beam makes the system complicated and limits the overall current density and duty factor.

Other disadvantages are presented with this approach. First, for only the very small percentage of the duty cycle when the beam sweeps across the opening of the collimator slit does the beam passes through the slit. During the remaining portion of the beam sweep, the beam is lost on the collimator itself In order to dissipate the power deposited on the collimator electrode, active water cooling is also needed. For deuterium ion beam acceleration, since the ions impinge on the collimator with tens of KeV energy, substantial amounts of neutrons are also generated by the D+D fusion reaction. This results in the generation of a high level of background neutrons which interfere with interrogation measurements.

In another approach, such as reported in PCT/US2007/087560, Leung et al., the ion beam is swept past a target material, that portion of the beam not “on target” being received by a beam dump. Neutron beams are generated only when the swept ion beam is “on-target”. In this scheme, the beam pulse width is determined by the speed of transverse sweeping and both the beam and target size. One problem with this approach is the technical difficultly of machining a small target with active water cooling.

Still another approach to beam pulsing has been to control ion extraction. This has been achieved by controlling the extraction gap, as explained in commonly owned U.S. Pat. No. 6,985,553 to Leung et al. In this approach an ion beam is extracted from a single or multi-aperture plasma ion source using two spaced electrodes, a plasma electrode and an extraction electrode. To produce ultra short ion or neutron pulses the apertures in the extraction system are suitably sized to prevent ion leakage, the electrodes suitably spaced, and the ion beam current leaving the source regulated by applying short voltage pulses of a suitable voltage to the extraction electrode.

Notably, at the beam “off” condition, the positive bias voltage applied to the extraction electrode pulls electrons from the ion source plasma. These extracted electrons may bombard the extraction electrode causing damage. They can also ionize the background gas in the channel and create a localized plasma. If the aperture size is small enough (in the order of micrometers), most electrons can't escape even at reverse bias. However, for micro-sized apertures, the thickness of the extraction electrode will be on the order of tens of microns (in order to keep the proper aspect ratio), which makes it quite fragile and less heat resistant.

Notwithstanding these various approaches, among others (such as achieving beam pulsing by switching the plasma on and off within the ion source, e.g. by pulsing the RF power at the ion source), there remains the need for a robust, compact and simplified means for obtaining pulsed ion beams of very short duration with fast fall time.

### SUMMARY OF THE INVENTION

An apparatus and method are described herein for obtaining short pulse width/fast fall time ion beams. These beam pulsing results are achieved by the application of a retarding potential (gating) to one of the extraction electrodes in a multi electrode extraction system.

In an embodiment of the invention, an apparatus is provided including an ion source and an ion beam extraction system comprising three electrodes. In this embodiment, the first electrode forms the face plate of the ion source, and is maintained at a potential V₁ which is typically the same potential as that of the ion source housing. This first extraction (i.e. plasma) electrode is positioned adjacent the plasma, and is provided with one or more apertures, this electrode serving to both contain the plasma within the ion source, and provide an exit pathway for the extracted ions used to form the ion beam. The second, or puller electrode, is closely spaced to the first electrode to define a first gap. This electrode is maintained at a voltage potential V₂ which is negative relative to the voltage potential V₁ of the plasma electrode (V₁>V₂), which effectively “pulls” the ions from the ion source through the apertures provided in the plasma electrode. Here, the bias of the second electrode provides a forward bias in the first gap, with electrons of the plasma separated out in this first gap.

A third electrode, the gating electrode, is closely spaced downstream from the second electrode to define a second gap, and is maintained at a third potential V₃. In the beam “on” mode, the potential V₃ of this electrode is less than that of V₁. Typically V₃ is equal to or less (i.e. more negative) than the potential of the second electrode (V₃≦V₂), which allows the extracted ions to continue on their acceleration path to the target. In the beam “off” mode, the potential of the third electrode V₃ is raised above the potential of the first electrode V₁ to an appropriate set point such that the flow of ions is stopped. Here, V₃>V₁. In operation, V₁ and V₂ can be preset. Then V₃, in one embodiment, can be pulsed from a preset low potential where V₃≦V₂<V₁ to a set high potential where V₃>V₁ to stop ion beam flow. In this embodiment, the operational bias is beam “on”, with the pulse set to raise V₃ to interrupt beam flow. In a second mode of operation, where the operational bias is beam “off”, V₁ and V₂ can be preset to permit beam flow. Initially set high where V₃>V₁ (beam “off”), the third electrode can be “pulsed” (that is, dropped) to a low potential where V₃≦V₂<V₁, thus permitting the beam to pass to the target.

In an embodiment of the invention, a forth electrode is positioned fairly close to the third electrode, this electrode maintained at a potential V₄. This potential V₄ can be equal to or less than V₃ to both pass and/or further accelerate the beam, and effectively shield the extraction system from the field created by the strongly negative potential V₅ of the target, V₅ accelerating the ions of the ion beam to the target at their required final energy.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1A is a schematic drawing of a gated pulsed neutron generator according to an embodiment of the invention.

FIG. 1B is a schematic drawing of the experimental setup for the beam pulse measurements reported hereafter.

FIGS. 2A and 2B are illustrations of multiple aperture extraction systems according to embodiments of the invention for a linear beam line.

FIGS. 3 and 4 are plots depicting various performance features of this invention according to the embodiments of FIG. 2.

FIG. 5 is a schematic top view and cut away section of a co-axial neutron generator employing the pulsed beam gating apparatus of this invention.

### DETAILED DESCRIPTION

By way of this invention, a compact neutron generator is described which employs a multiplicity of small ion beamlets at low energy, in combination with an array of electrodes to effectively gate the ion beamlets. More particularly, in an exemplary embodiment of the invention, an array of 0.6-mm-diameter apertures is employed as opposed to one 6 mm diameter aperture such that gating the beamlets can be done with low voltage and a small gap to achieve sub-micro second ion beam fall times with low levels of background neutrons. Arrays of 16 apertures (4×4) and 100 apertures (10×10) were designed and fabricated for beam extraction experiments. In these experiments, using a gating voltage of 1200 V and a gap distance of 1 mm, the fall time of extracted ion beam pulses was measured at approximately 0.15 micro seconds at beam energies of 1000 eV.

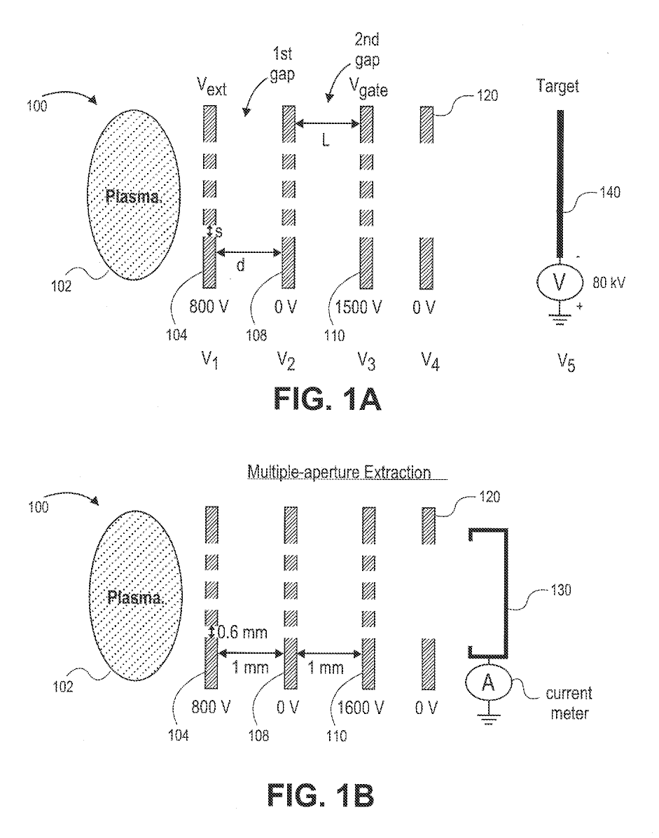

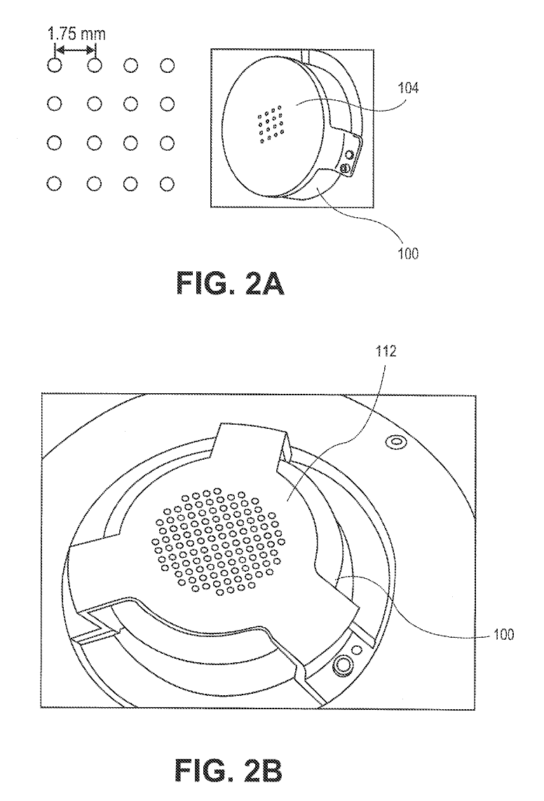

FIG. 1A illustrates the gating system of this invention. Here, a plasma 02 is formed in ion source 100 (not shown) from a gas comprising either deuterium or tritium, or a mixture of both. In one embodiment an RF antenna (not shown), and in another embodiment a microwave source is used to provide the energy input required to generate the plasma.

A first plasma extraction electrode 104, having multiple extraction apertures of diameter “s”, which in one embodiment forms the faceplate of ion source 100, is typically held at the potential V₁ of ion source 100. A second apertured electrode 108 spaced a distance “d” from electrode 104, defining a first gap, is used to extract the D⁺ or T⁺ ions from source 100. (For normal beam optics, the diameter of an extraction aperture “s” will be smaller than gap “d”.) The potential V₂ of electrode 108 is set below the potential V₁ of electrode 104 so as to effectively “pull” the ions from the plasma maintained within source 100 and through the apertures of electrode 104. The forward bias in the gap between electrode 108 and next electrode 110, when operated in the beam “on” mode allows the extracted ions to continue their acceleration to the target.

A third (gating) electrode 110, defining a second gap, is maintained at a potential V₃ that in one embodiment is equal to or slightly less than the potential V₂ of the second (puller) electrode. In this embodiment, electrons of the plasma are separated out in the first gap “d” between plasma electrode 104 and puller electrode 108.

A pulsed change in the potential applied to gate electrode 110 can be used to either stop or start the ion flow, depending upon whether or not it is initially set at low or high position. This gating voltage V₃ needs to be higher but doesn't need to be much higher than the plasma electrode voltage V₁ to stop ion flow. Just how much higher it is set is not critical: the differential required to achieve beam stoppage can be determined by routine trial and error for the particular beam system under consideration.

It is to be appreciated that the system can be operated in one of two modes, where either the bias is to beam “on” or beam “off”. Here, pulsing of the third electrode serves to either stop beam flow (by being pulsed to a higher potential than V₁), or turn it on (by dropping the potential to one that is lower than V₁, and preferably equal to or below V₂). In the case of DDA analysis either mode may be used as beam fall time is rapid in either mode. In the case of PFNTS analysis, bias to beam “off” mode may be preferable, it being potentially easier to electronically generate shorter beam “on” pulses.

Standard, commercially available power supplies can be used for powering the plasma and puller electrodes 104 and 108, respectively. A pulsed voltage power supply is used to provide the voltage change to the third, gating electrode 110. In one embodiment, the second power supply may also include pulsing capability, and for ease of manufacturing, in yet another embodiment, the same type of pulsed power supply can be used with all three electrodes. In addition to the ability to set output voltages, in the case of a power supply having a pulsing feature, the power supply should also be programmable so that both a first and second voltage level may be selected, as well as the time (the duty cycle) at which the output is maintained at said first or second voltage. Generally, while the potential of each electrode can be set as desired, once voltage levels are set, in operation they remain fixed.

The smaller the aperture openings, the smaller the distance between the various electrodes can be, and thus the more compact the overall length of the accelerator column can be, all of which facilitates the extraction of ions at low voltage. Using low voltage also minimizes the problem of voltage breakdown as well as reduces the time of flight to produce faster gating. In addition, low voltage is preferred because it not only makes the pulsing instrumentation easier, but also results in lower capacitive stored energy between electrodes, which is easier to accommodate electronically.

For a compact neutron generator to achieve less than 1 μs pulse fall time, given the beam current requirements, it has been found preferable to gate multiple small ion beamlets at low energy, as opposed to gating a single, large beam of the same total beam current. Fast fall time requires a small gap between electrodes, which in turn requires small openings “s”. Thus, to meet beam current requirements, multiple beamlets are extracted at small s and low V₁. So doing, gating voltage V₃ doesn't need to be much higher than the extraction voltage V₁ to stop the ion flow.

Returning to FIG. 1A, the generator includes a target 140 containing D⁺ and T⁺ ions. Exemplary of targets for use in this application are titanium films on copper substrates. The titanium film can be preloaded with deuterium or tritium, or it can be beam loaded with D⁺ or T⁺ beam at operation startup. In the illustrated embodiment, the target is maintained at a strongly negative voltage V₅ relative to the beamlets to further accelerate the ions from source 100 to their final energy before they strike the target. In FIG. 1A, exemplary voltages are shown for the system when it is in blocking or beam “off” mode. In the beam “on” mode, V₂ would be set at 0V or at a minus voltage. While the electrodes are maintained a relatively modest voltages, by way of the example, the target is maintained strongly negative, for example −80 KV, in order to accelerate the ions to the relatively high energies required for generating neutrons upon impact with the D⁺ and T⁺ ions at the target.

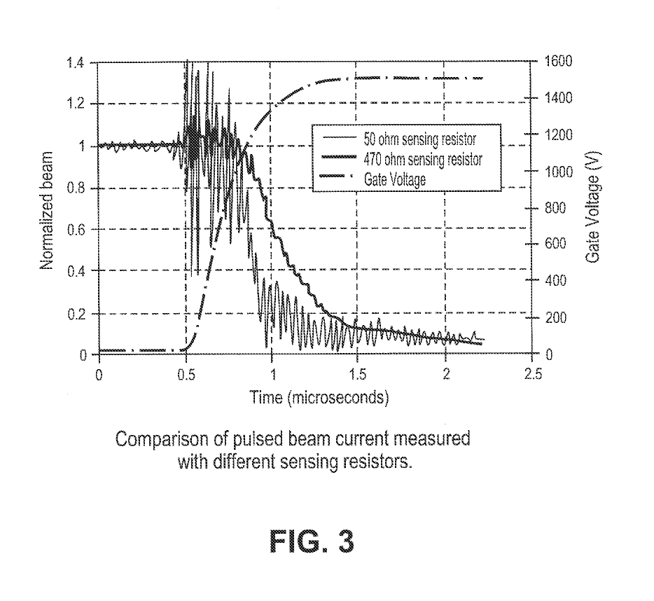

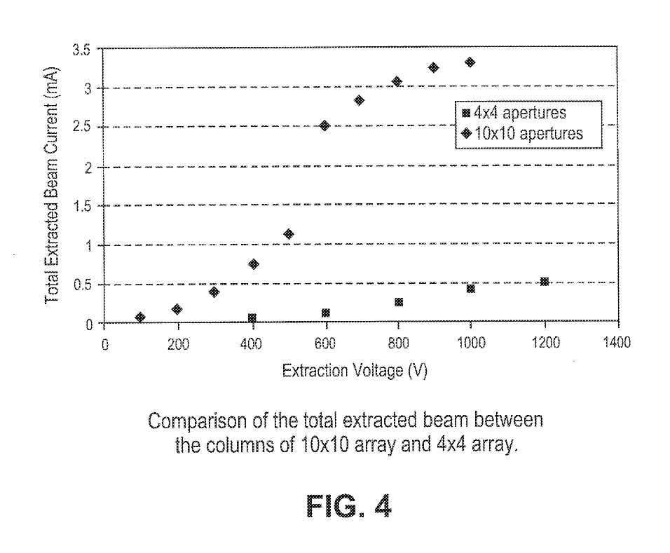

In an experiment using an ion source having multiple beam apertures, as shown in FIG. 1B and FIG. 2A, a hydrogen plasma was generated , as a beam test, using a 2.45 GHz microwave-driven ion source. The detailed description of the ion source is reported by J. Kwan et al in Reference [4]. The plasma chamber of the experiment is 9.2 cm in diameter and 12.7 cm long. Microwave power is transmitted via a rectangular waveguide through an aluminum nitride window into the plasma chamber. An axial magnetic field, that is required to set up the electron cyclotron resonant condition, is produced by passing approximately 109 amp of dc current through field coils. In the experiment, the microwave power was set at 320 W and the gas flow was at 0.5 sccm. Hydrogen ions are extracted from an array of 4×4 apertures (FIG. 2A) with each aperture 0.6 mm in diameter. The center-to-center distance between adjacent apertures is 1.75 mm. Thus the grid transparency is around 13%. The voltage V₁ of extraction electrode 104 was varied from 400 V to 1200V, and the peak voltage V₃ of the gating power supply (not shown) varied from 800V to 1600 V. The rise-time of gating pulse was approximately 500 ns, and the pulse width was 5 μs. The fourth electrode 120, was maintained at a potential V₄ of 0 volts, this electrode inserted to reduce the capacitive coupling current induced by the gating voltage in the Faraday cup 130 (in the experiment maintained at ground potential). To further explore the actual limits of the pulse fall-off time, different sensing resistors were used to determine the RC delay in the diagnostic circuitry. As shown in FIG. 3, with a sensing resistor of 50 ohms, fall time is significantly reduced from 0.6 is to approximately 0.15 μs.

FIG. 4 is a comparison of the pulsed beam currents extracted using plasma electrodes having 4×4 apertures and 10×10 apertures. In both cases, the extraction voltage V₁ was 400V and the gate voltage was set at 1200 V. As shown in FIG. 4, the total ion beam for the 10×10 column matrix is more than five times higher than that in the 4×4 column. When extracted at 1 kV, the beam “on” beam level reached as high as 3.3 mA.

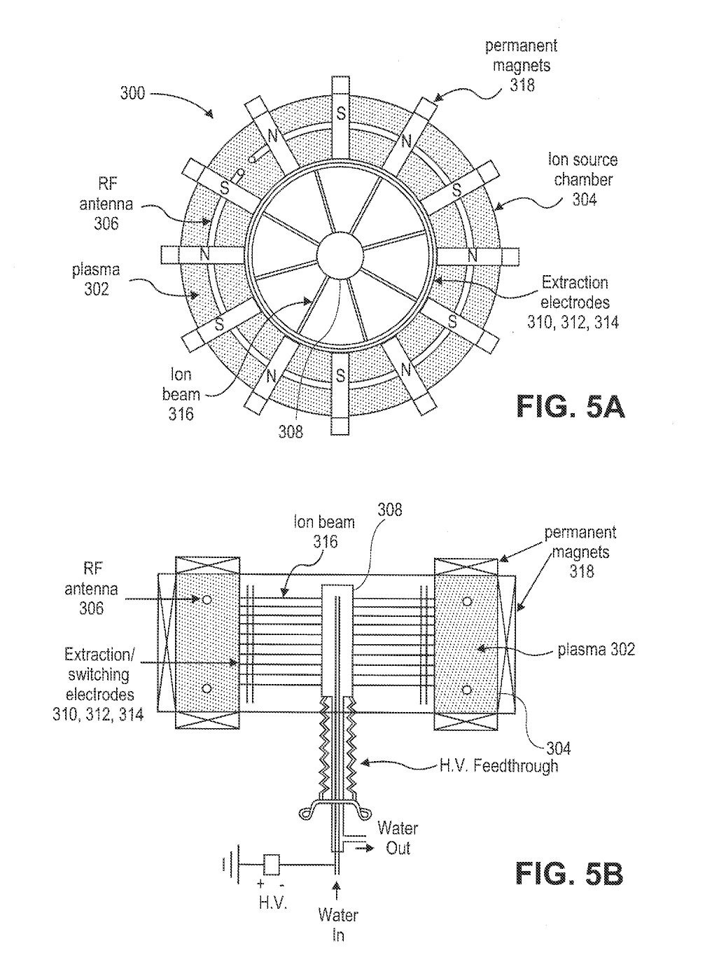

In the preceding discussion, the ion source and gating means for turning the beam on and off has been described in connection with a linear, i.e. axial generator. The principals described herein, however, are equally applicable to a co-axial neutron generator such as described in commonly owned and issued U.S. Pat. Nos. 6,870,894, 6,907,097 and 7,362,842 to Leung, et al. With reference to FIG. 5, an example of such a co-axially configured generator 300 is illustrated wherein a deuterium or tritium plasma 302 is produced in a torroidal ion source chamber 304 by RF induction discharge using a single turn internal antenna coil 306. This antenna can be made of quartz tubing with metal conductor at the center. For high power operation, the antenna tubing is cooled by passing air or water. The ion source chamber 300 is surrounded with permanent magnets 318 for plasma confinement and for low pressure discharge operation.

As illustrated, the plasma chamber is positioned to the outside of the device with the target positioned at its center. Beamlets exiting the plasma source are thus directed from the periphery of the chamber to its center, where they strike the chamber target. It is to be appreciated that as disclosed in the cited patents, the organization of the generator can be reversed, such that the plasma source is in the center of the chamber, with the target disposed to the periphery of the generator. In either case, the electrodes would be arranged in the same order as is shown for the axial arrangement as depicted in FIG. 1.

For either of the two arrangements in the case of the coaxial generator or in the case of the axial generator, for ease of construction, and durability and to better electrically isolate the electrodes each one from the other, they can be separated by a dielectric/insulating material such as ceramic.

With reference again to FIG. 5, to the center of the chamber 300 is neutron target 308 which is a titanium target, similar in construction to that previously described. Also, similar to the electrode arrangement of FIG. 1A, a cylindrical extraction (plasma) electrode 310 contains a plurality of apertures (not shown) aligned vertically, thus acting as an apertured electrode extraction “column”, to extract a column of beamlets 316 towards cylindrical titanium target tubing 308, which is water or air-cooled. Electrode 312 defining the first gap is set to a potential V₂ which is lower than the potential V₁ of electrode 310, thus pulling the ions from the plasma source. Electrode 314 acts as the gating electrode, and when set to voltage V₃ which is higher than voltage V₁ serves to stop the flow of ions to the target. Thus, in beam “off” mode, V₃>V₁≧V₂. In another embodiment where V₁>V₂≧V₃, after exiting the column, ions of the multiple beamlets will be accelerated to the target primarily due to the negative high voltage applied to the target, and impinge on it with the full potential energy. As with the axial arrangement, a forth electrode (not shown) can be positioned between the third electrode 314 and target 308 to isolate the extraction/gating system from the acceleration zone. Neutrons will be generated by the fusion processes on the target surface.

If the potential of a third electrode V₃ is increased to a value higher than the plasma potential V₁, the ions will be stopped at the entrance of the third electrode by the potential barrier. As a result, no ions will arrive at the target, and therefore no neutrons will be produced. In order to form 2 ns neutron pulse lengths, a short voltage pulse (2 ns pulse length) is applied to the third electrode. If small micron size (50 to 100 μm in diameter) apertures are used, the voltage V₃ needed to switch off the ion beam will also be small. Only a 2 ns low voltage pulser is needed in this system operation.

In an alternative operational mode for the coaxial design of FIG. 5, all three electrodes can be maintained at the potential of the ion source, where V₃=V₁=V₂, and the positive deuterium or tritium ions thus enter the column with energy equal to the plasma potential. After exiting the extraction column, they are accelerated to the target to impinge on it at the full target potential. In this embodiment, if the potential of the second (rather than the third) electrode is increased to a value higher than the plasma potential, the ions will be stopped at the entrance of the second electrode by the potential barrier. As a result, no ions will arrive at the target and therefore no neutrons will be produced. In this mode, operating at the plasma potential which is typically in the order of 10-20 or so electron volts, the voltage increase of V₂ above V₁ needed to switch off the ion beam will also be quite small (in the order of 15 to 20 volts, or so). In this alternative operational mode, one consideration is that in beam “off” mode, electrons will be extracted from the plasma, some of which will pass through the electrode openings, while others will strike the electrodes themselves.

The neutron source size can be adjusted by choosing the proper diameter of the target tubing 308. The overall dimension of the device is one embodiment is approximately 25 cm in diameter and 12 cm in height. Pure deuterium discharge operation will produce mono-energetic 2.4 MeV D-D neutrons while pure tritium discharge operation will provide a neutron spectrum with energy ranging from 0 to 9 MeV. Mixing of deuterium and tritium gas in the discharge will form 14 MeV D-T neutrons. For PFNTS applications, a “white spectrum” is needed. For this reason, the device is operated with pure tritium.

With either the axial or coaxial neutron generator, the smaller the extraction apertures contained within the first plasma electrode, the lower the voltage differential required to extract the ions from the plasma source. Also the lower the extraction voltage, the smaller differential required to block the flow of ions which can further reduce beam “on” times.

### REFERENCES

1. B. D. Rooney et al., “Active Neutron Interrogation Package Monitor”, IEEE Nuclear Science Symposium, 1998, Conference Record, Vol. 2, 1998, p. 1027.

2. K. A. Jordan, and T. Gozani, “Detection of ²³⁵ U in Hydrogenous Cargo with Differential Die-Away Analysis and Optimized Neutron Detectors”, Nucl. Instr. and Meth. A 579 (2007) 388.

3. Q. Ji, J. Kwan, M. Regis, Y. Wu, S. B. Wilde, J. Wallig, “Fast Fall-time Ion Beam in Neutron Generators”, 20th International Conference on Application of Accelerators in Research and Industry, AIP Conf. Proc. 1099 (2009) 660.

4. J. W. Kwan, R. Gough, R. Keller, B. A. Ludewigt, M. Regis, R. P. Wells, and J. H. Vainionpaa, “A 2.45 GHz High Current Ion Source for Neutron Production”, 17th International Workshop on ECR Ion Sources and Their Applications September 17-21, 2006, IMP, Lanzhou, China.

### CONCLUSION

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

It is to be understood that the above description and examples are intended to be illustrative and not restrictive. Many embodiments will be apparent to those of skill in the art upon reading the above description and examples. The scope of the invention should, therefore, be determined not with reference to the above description and examples, but should instead be determined with reference to the appended claims, along with the full scope of equivalents to which such claims are entitled. The disclosures of all articles and references, including patents, patent applications, and publications, are incorporated herein by reference for all purposes.

What is claimed is:

1. An electrode extraction system for generating a pulsed ion beam, comprising:
a plasma ion source suitable for the generation of deuterium or tritium ions;
a first electrode adjacent said plasma source, said electrode containing at least one opening through which ions generated within said plasma source may exit the source;
a second electrode spaced a distance from said first electrode to define a first gap, said second electrode containing at least one opening downstream of the opening in said first electrode, and through which ions may pass;
a third electrode spaced a distance from said second electrode to define a second gap, said third electrode containing at least one opening downstream of the opening in said first, and second electrodes, said openings in said electrodes aligned to define a path for an ion beam to pass;
a first variable power source connected to said first electrode, said first power source capable of maintaining said first electrode at a first voltage V₁;
a second variable power source connected to said second electrode, said second power source capable of maintaining said second electrode at a second voltage V₂ which voltage may be adjusted to be the same, or higher or lower than the voltage V₁;and
a third variable power source connected to said third electrode, wherein said third power source may be pulsed, said third power source capable of maintaining said third electrode at a voltage V₃ which in one condition is the same or lower than the voltage V₂ and in another condition is higher than the voltage V₁.

2. The electrode extraction system of claim 1, wherein the first electrode is maintained at the same voltage potential as said ion source.

3. The electrode extraction system of claim 2 wherein the first electrode is maintained at a voltage V₁, the second electrode maintained at a voltage V₂ which is lower than V₁ in order to pull ions from the ion source, and which in the beam on condition, said third electrode is maintained at a voltage V₃ which is the same or less than voltage V₂.

4. The electrode extraction system of claim 3, wherein the third electrode is programmed to be pulsed to a voltage V₃ which is higher than V₁ so as to create a beam off condition, in which the passage of ions through the at least one aperture in the third electrode is stopped by the electric field generated in said second gap.

5. The electrode extraction system of claim 2 wherein the first electrode is maintained at a voltage V₁, the second electrode maintained at a voltage V₂ which is lower than V₁ in order to pull ions from the ion source, and said third electrode is maintained at a voltage V₃ which is higher than voltage V₁, whereby the passage of ions through the at least one aperture in the third electrode is stopped by the electric field generated in said second gap.

6. The electrode extraction system of claim 5, wherein the third electrode is programmed to be pulsed to a voltage V₃ which is lower than V₁, so as to create a beam on condition, in which the passage of ions through the at least one aperture in the third electrode is allowed.

7. The electrode extraction system of claim 6 wherein the third electrode is programmed to be pulsed to a voltage V3 which is equal to or lower than V₂ so as to create a beam on condition, in which the passage of ions through the at least one aperture in the third electrode are allowed.

8. The electrode extraction system of claim 1 wherein in a beam on condition, the first, second and third electrodes are maintained at the same voltage.

9. The electrode extraction system of claim 8 wherein said power source to said second electrode may be pulsed, and in a beam off condition, the first and third electrodes are maintained at the same voltage, while the second electrode is pulsed to a voltage which is sufficiently greater than the voltages of the first and third electrodes so as to stop the flow of ions coming from the plasma ion source.

10. The extraction system of claim 1 wherein said third power source is capable of being pulsed for less than 10 micro seconds.

11. The extraction system of claim 10 wherein said third power source is capable of being pulsed for less than 10 nano seconds.

12. A fast pulsed neutron generator including the electrode extraction system of claim 1, and further including;
a source of deuterium and tritium gas in fluid communication with said plasma ion source;
an energy source for the ionization of deuterium and tritium gas resident within said ion source; and,
a titanium target spaced downstream from and aligned with said third electrode to receive an ion beam passing though said electrode, said titanium target containing deuterium or tritium ions.

13. The fast pulsed neutron generator of claim 12 wherein the at least one opening in each of said electrodes comprises a multiplicity of openings in each of said three electrodes, the openings aligned electrode to electrode so as to define a multiplicity of passages for an equal number of ion beamlets.

14. The fast pulsed neutron generator of claim 12 further including a fourth electrode positioned between said third electrode and said target.

15. The fast pulsed neutron generator of claim 12 wherein the generator is an axial system.

16. The fast pulsed neutron generator of claim 12 wherein the generator is a co-axial system.

17. A method of generating a fast pulsed stream of neutrons employing the apparatus of claim 12, wherein the first plasma electrode is maintained at V₁ volts, the second puller electrode is maintained at V₂ volts, where V₁>V₂, and the third, gating electrode is maintained at V₃ volts, where V₃ is equal to or less than V₂ when the generator is operating in a beam on condition, and V₃ is greater than V₁ when the generator is operating in a beam off condition.

18. A method of generating a fast pulsed stream of neutrons employing the apparatus of claim 12, wherein the extraction first plasma electrode is maintained at V₁ volts, the second puller electrode is maintained at V₂ volts, where V₁>V₂, and the third, gating electrode is maintained at V₃ volts, where V₃ is greater than V₁ when the generator is operating in a beam off condition, and is pulsed to a potential for operating in a beam on condition, where V₃ is less than or equal to V₂.

19. The method of claim 12 wherein the gas used to generate the plasma is selected from deuterium, tritium, or a mixture thereof.

20. The method of claim 12 wherein V₁ and V₂ are set at a predetermined value and fixed during a multiplicity of beam-on/beam-off sequences, and V₃ is set to a voltage which is the same as or less than the set voltage V2 in beam-on mode.

21. The method of claim 12 wherein V₁ and V₂ are set at a predetermined value and fixed during a multiplicity of beam-on/beam-off sequences, and V₃ is set to a voltage in which V₃>V₁ in beam-off mode.
